(19) United States
(12) Patent Application Publication
(10) Pub. No.: US 2010/0037958 A1
(43) Pub. Date: Feb. 18, 2010

(54) Gas Delivery Method & Device

(75) Inventors: Andrew Duncan Tassell, Overton (GB); Neil Alexander Downie, Odiham (GB); Richard Wiktorowicz, Aylesbury (GB)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: Air Products and Chemicals, Inc., Allentown, PA (US)

(21) Appl. No.: 12/467,489

(22) Filed: May 18, 2009

(30) Foreign Application Priority Data
Aug. 15, 2008 (EP) 08162454.6
May 14, 2009 (WO) 2009055882

(51) Int. Cl. G05D 11/02

(52) U.S. Cl. 137/3; 137/98

(57) ABSTRACT

Gas is delivered to a locus from a gas delivery device (1), which is spaced from the locus and comprises an inner pipe (2) and an outer pipe (3) axisymmetrical with and surrounding said inner pipe (2) to form an annular conduit (4). A first gas is fed to the inner pipe to exit as a laminar flow jet impinging on the locus and a second gas is fed to the annular conduit to exit as a turbulent flow annular sleeve surrounding and constraining diffusion of said jet. In a preferred embodiment, normoxic air is fed to both the inner pipe and the conduit and oxygen is introduced into the inner pipe at an intermediate location so that the jet is oxygen-enriched air for inhalation by a user at the locus.

### BACKGROUND OF THE INVENTION

The present invention relates to reducing the diffusion of a gas jet impinging on a locus spaced from an outlet through which the jet is delivered. It has particular, but not exclusive, application to the supply of oxygen-enriched air to be inhaled by a person exercising or operating machinery at a static location or operating, controlling or travelling in a motor or other land, sea or air vehicle. The invention provides both a method of delivering gas and a device for use in a preferred embodiment of the method.

It is well known that inhaling oxygen-enriched air has an ergogenic effect. In particular, it increases the capacity for physical performance by improving exercise tolerance and/or reducing exercise fatigue whilst breathing the oxygen-enriched air or improving athletic ability or fitness after such exercise. It can provide greater reduction in, or improved maintenance of, body mass index and improvement in oxygen conversion efficiency over and above that achievable during normoxic exercise. Usually, oxygen concentrations in excess of 25% are used and, at these concentrations, the gas must be administered using a mask or cannula and must be carefully monitored for both medical and safety reasons. However, lower concentrations of between 22 and 25% have been demonstrated to produce an ergogenic effect. For example, there is a very significant improvement in ergogenic effect at an oxygen concentration of about 24% compared with normoxia (i.e. 21% oxygen). At these concentrations, it is unnecessary to employ a mask or cannula to administer the gas and it can be delivered directly to the face of the user via a non-intrusive device. For example, EP 0028209A discloses a bicycle ergometer in which oxygen-enriched air can be directed to the face of the user from a device mounted on the ergometer. However, the nature of the device and the spacing from the user's face is such that diffusion will cause a significant reduction in oxygen concentration by the time that it is inhaled.

### BRIEF SUMMARY OF THE INVENTION

The primary objective to which the present invention is directed is to constrain diffusion of a jet of oxygen-enriched air directed for inhalation by a person spaced from the orifice from which the jet issues. However, more generally, the problem to which the invention is directed is the diffusion of gas from a jet into the ambient atmosphere that results in compositional changes in the jet as it propagates through the atmosphere. The Inventor has found that a solution is to produce the jet with laminar flow and to surround it with an annular sleeve of otherwise turbulent gas.

According to a first aspect, the present invention provides a method of delivering a gas to a locus comprising feeding a first gas to the inlet of the inner pipe (2) of a gas delivery device (1), which device is spaced from the locus and comprises an inner pipe (2) having an inlet at one end and an outlet at the other end and an outer pipe (3) axisymmetrical with and surrounding said inner pipe (2) to form an annular conduit (4) having an inlet at said one end and an outlet at said other end, and feeding a second gas to the inlet of the annular conduit (4), wherein gas issues from the inner pipe outlet as a laminar flow jet impinging on the locus and surrounded by a turbulent flow annular sleeve issuing from the annular conduit and constraining diffusion of said jet until at least said locus.

In a second aspect, the invention provides a gas delivery device (1) for use in a preferred method of said first aspect and comprising:

an inner pipe (2) having an inlet at one end and an outlet at the other end and through which pipe a gas can flow from the inlet to exit at the outlet as a laminar flow jet;

an outer pipe (3) axisymmetrical with and surrounding said inner pipe (2) to form an annular conduit (4) having an inlet at one end and an outlet at the other end and through which conduit a gas can flow from the inlet to exit at the outlet as a turbulent sleeve surrounding said jet; and

a supply pipe (6) for introducing matter into the inner pipe (2) at an intermediate location thereof to change the composition of the gas flowing therethrough.

The device used in the method of the invention preferably comprises, as in the second aspect, a supply pipe for introducing matter, especially a gas, into the inner pipe to change the composition of gas flowing therethrough. In such a device, the respective inlets of the inner and outer pipes can be connected to a common manifold so that gas of the same composition enters both the inner pipe and the annular conduit. Although the supply pipe can introduce matter in the axially direction of the inner pipe or at an angle thereto, it is preferred that matter is introduced omnidirectionally by, for example, a system of orifices in the wall of an otherwise closed supply pipe, or, especially, isokinetically (i.e. at the same velocity as the gas flowing through the inner pipe).

Vanes can be provided for imparting swirl to the annular sleeve and it is preferred that such vanes are located at the outlet of the annular conduit.

As mentioned previously, the gas delivery device of the invention has particular application to the supply of oxygen-enriched air. In one preferred embodiment, oxygen-enriched air is fed to the inner pipe and normoxic air is fed to the annular conduit. In another preferred embodiment, normoxic air is fed to both the inner pipe and the annular conduit and oxygen is introduced into the inner pipe at an intermediate location. The normoxic air can be provided by an air pressure line or a compressed air cylinder but, when a device is intended for stand-alone use, it is provided by a fan fed with ambient air. The oxygen can be provided by any suitable oxygen source. In the first of said preferred embodiments, the oxygen-enriched air usually will be provided by a portable oxygen generator concentrator in which known adsorption or membrane separation techniques are used. In the second of said embodiments, the oxygen usually will be provided by a cylinder of compressed oxygen or a portable oxygen generator concentrator.

Usually, the pipes will be rigid but they may be flexible provided that the device performs in an essentially consistent manner. Although the inner and outer pipes can be of different lengths, it is preferred that they are substantially coextensive. It is also is preferred that both the inner and outer pipes are right circular pipes, that they terminate at their outlets in the same plane, and/or that one or both have a feather- or taper-edge at the outlet end (i.e. a gradual decrease in wall thickness in the flow direction to minimize flow disruption on debauching from the pipe.

In order to ensure a steady flow regime, the annular conduit suitably has a length at least about six times the diameter of the inner pipe. Especially when the jet is oxygen-enriched air and the sleeve is normoxic air, the inner pipe suitably has a diameter of about 40 to about 140 mm (about 1.5 to about 5.5 in), preferably about 50 to about 100 mm (about 2 to about 4 in), and especially about 50 to about 70 mm (about 2 to about 2.75 in); the outer pipe suitably has a diameter of about 50 to about 150 mm (about 2 to about 6 in), preferably about 60 to about 120 mm (about 2.25 to about 4.75 in), and especially about 70 to about 100 mm (about 2.75 to about 4 in) diameter; and, subject to being at least about six times the inner pipe diameter, the length of the annular conduit suitably is about 0.3 to about 0.75 m (about 12 to about 30 in), preferably about 0.4 to about 0.6 m (about 15 to about 24 in), and especially about 0.45 to about 0.55 m (about 17 to about 22 in). Suitably, the cross-sectional areas of the inner pipe and the annulus between the inner and outer pipes are similar in that one area is not more than about 25% greater or smaller than the other and can be substantially the same.

The diameters referred to above are internal diameters and in the case of the outer pipe assume that the inner pipe wall is of negligible thickness. Accordingly in practice of the invention, appropriate adjustments to the specified diameters should be made to take account of the actual wall thickness.

Usually, the inner pipe outlet will be spaced about 200 to about 500 mm from the locus at which the jet is to impinge and accordingly the dimensions and operating parameters of the device will be selected having regard to the jet composition required at the locus. In the case of provision of oxygen-enriched air for inhalation, it is preferred, for safely reasons, that the oxygen concentration in the jet exiting the inner pipe outlet is about 25% and that the concentration at the locus is at least about 22%, preferably about 23 to about 24%.

It is preferred, especially when providing oxygen-enriched air for inhalation, that the flow exiting the annular conduit has a Reynolds Number of at least about 3000. The annular gas sleeve may have a rotational velocity of, for example, about 80 to about 800 rpm. Preferably, the jet leaving the inner pipe has a rotational velocity of less than about 60 rpm, especially substantially no rotational velocity.

It also independently is preferred, especially when providing oxygen-enriched air for inhalation, that the linear flow velocity of gas exiting the inner pipe outlet is about 30 to about 65 m/s, more preferably about 45 to about 55 m/s and especially about 50 m/s. Thus, when the gas is passing through a 65 mm (2.6 in) diameter inner pipe, the flow rate of gas exiting the inner pipe outlet is preferably about 100 to about 220 litres/minutes, more preferably about 150 to about 190 litres/minute and especially about 170 litres/minute. Usually, the axial flow velocity in the inner pipe and in the annulus between the inner and outer pipes are similar in that the velocity in one is not more than about 25% greater or smaller than in the other. Preferably, the velocities are substantially the same.

### BRIEF DESCRIPTION OF SEVERAL VIEWS OF THE DRAWINGS

The invention will be description by way of example and with reference to the accompanying, in which:

FIG. 1 is a schematic drawing showing the basic principle of the preferred embodiment of the invention;

FIG. 2A is a longitudinal cross-section through a gas delivery device of the invention with the oxygen supply pipe not shown;

FIG. 2B is a cross-section on A-A of FIG. 2a;

FIGS. 3A, 3B & 3C are longitudinal sections of part of the device of FIG. 2A fitted with an oxygen supply pipe of respective geometry;

FIG. 4 is a longitudinal cross-section of the inlet end of the device of FIG. 2;

FIG. 5 is a graph based on a computer simulation showing the results achievable with the method of the present invention compared with a corresponding method using a single pipe device;

FIG. 6 is a graph based on a computer simulation showing the effect of flow rate ratio between the inner pipe and total flow rate in a method of the present invention;

FIG. 7 shows the measured decrease in oxygen concentration as the jet core progresses when using the device of FIG. 2 with the oxygen supply pipe of FIG. 3A;

FIG. 8 shows the measured decrease in oxygen concentration as the jet core progresses when using the device of FIG. 2 with the oxygen supply pipe of FIG. 3B;

FIG. 9 is a graph showing the measured effect on oxygen concentration of the swirl vanes of the device of FIG. 2;

FIG. 10 is a graph showing the measured effect on oxygen concentration of the location of the oxygen supply pipe of FIG. 3B in the device of FIG. 2;

FIG. 11 shows the measured decrease in oxygen concentration as the jet core progresses when using the device of FIG. 2 with the oxygen supply pipe of FIG. 3A, 3B or 3C;

FIG. 12 is a schematic drawing of apparatus used in Experiment 8 infra; and.

FIG. 13 is a graph showing the measured effect on oxygen concentration of variation in the oxygen flow rate and voltage applied to the fan of the apparatus of FIG. 12.

### DETAILED DESCRIPTION OF THE INVENTION

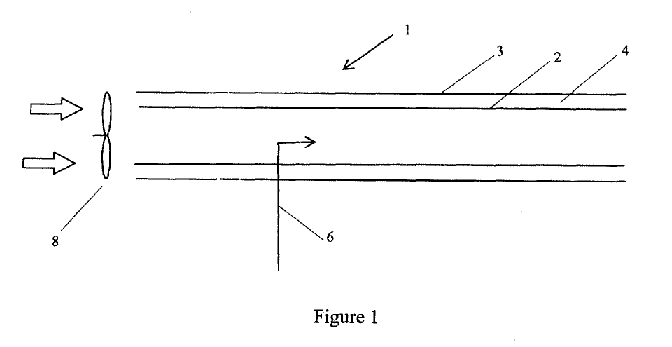

Referring to FIG. 1, a gas delivery device (1) of the invention has an inner pipe (2) surrounded by an axisymmetrical pipe to form an annular conduit (4). A fan (8) provides ambient (normoxic) air to both the inner pipe (2) and the annular conduit (4). Oxygen is introduced into the inner pipe (2) by an oxygen supply pipe (6). The oxygen can be provided by any suitable oxygen source and, for experimental purposes, a cylinder of compressed oxygen was used. However, in practice, oxygen usually will be supplied to the inner pipe from an oxygen generator concentrator in which known adsorption or membrane separation techniques are used to provide oxygen-enriched air.

The fan (8) can be replaced by another source of air, such as a compressed air supply pipe, or the fan can be enclosed in a housing closed to the ambient atmosphere to permit a gas other than ambient air to be supplied to the device. Further, the device can be modified by omission of the supply pipe and provision of separate feeds to the inner pipe (2) and the annular conduit (4) so that the feeds can have different compositions, for example normoxic air fed to the annular conduit and oxygen-enriched air fed to the inner pipe or an inert gas fed to the annular conduit and a reactive gas fed to the inner pipe. In welding applications, a shielding gas such as argon or an argon/CO₂ mixture could be fed to the inner pipe and normoxic air fed to the annular conduit.

In use when providing oxygen-enriched air for inhalation, the device will be directed towards the face of a person requiring to breathe the oxygen-enriched air. The distance between the user's face and the device will be determined primarily by the oxygen concentration available at the required distance. However, other considerations such as the extent to which the user may move, for example, during exercise, and the user's comfort with the proximity of the device may need to be taken into account. Usually, the jet will not be directed directly at the user's face but would be angled to both avoid deflection by the user exhaling and obstruction of the user's view.

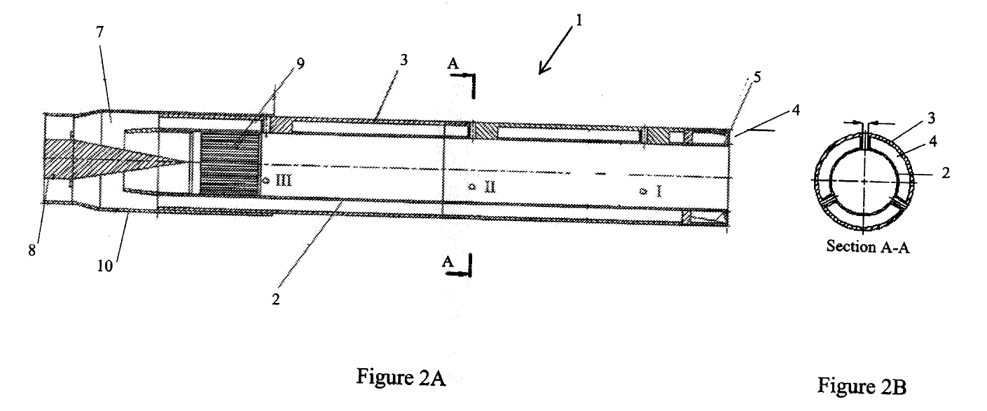

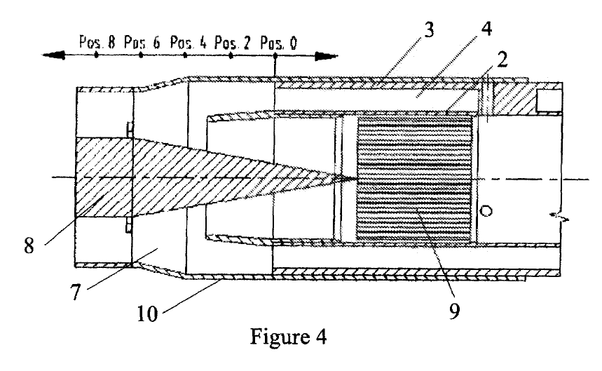

FIG. 2 shows a gas delivery device (1) used for experimental purposes to investigate the effect on diffusion of the jet stream by varying the distance between the fan and the inlets to the inner and outer pipes as described in Experiments 3 to 6 infra. The inlet end of the device is provided by a longitudinally movable part (10) in which the fan (8) is mounted and which defines a manifold (7) through which the inner pipe (2) and annular conduit (4) are supplied with normoxic air from the ambient atmosphere. As shown in FIG. 4, the movable part (10) can be moved in four 20 mm increments, from location POS.0 via locations POS.4 & POS.6 to POS.8.

A honeycomb (3) is provided at the inlet end of the inner pipe (2) to ensure a uniform velocity profile in the inner pipe.

Three locations (I, II & III) are provided as alternative locations for an oxygen supply pipe (6; not shown in FIG. 2). Optionally vanes (5) are provided at the outlet end of the annular conduit (4) to impart swirl to the annular sleeve formed by the gas stream exiting the annular conduit (4).

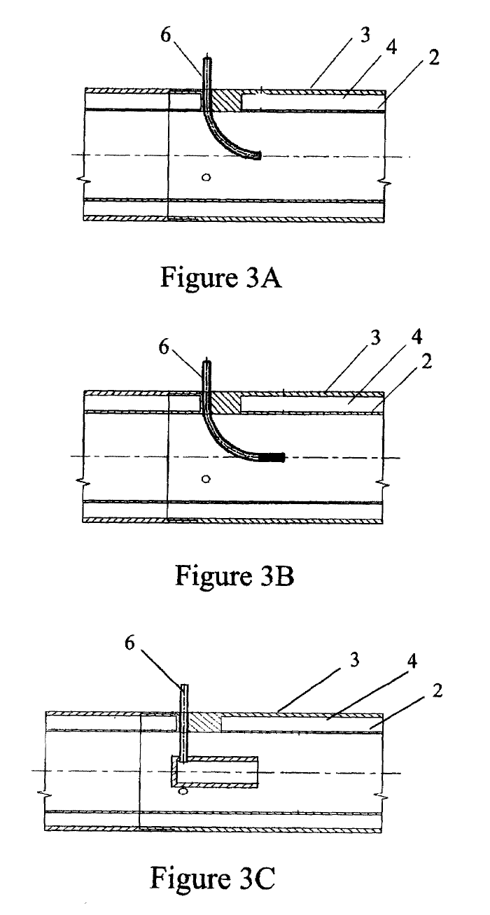

Three oxygen supply pipes (6) of different geometry are used in the device of FIG. 2. As shown in FIG. 3A, one oxygen supply pipe has a plain open end to supply the oxygen in an axially directed stream. In an alternative geometry shown in FIG. 3B, the end of the supply pipe is closed and a series of small holes are provided in the pipe wall so that the oxygen is supplied omnidirectionally. In another alternative geometry shown in FIG. 3C, the supply pipe terminates in a cylindrical section coaxially aligned with the inner pipe and of an internal diameter so that the oxygen is supplied isokinetically.

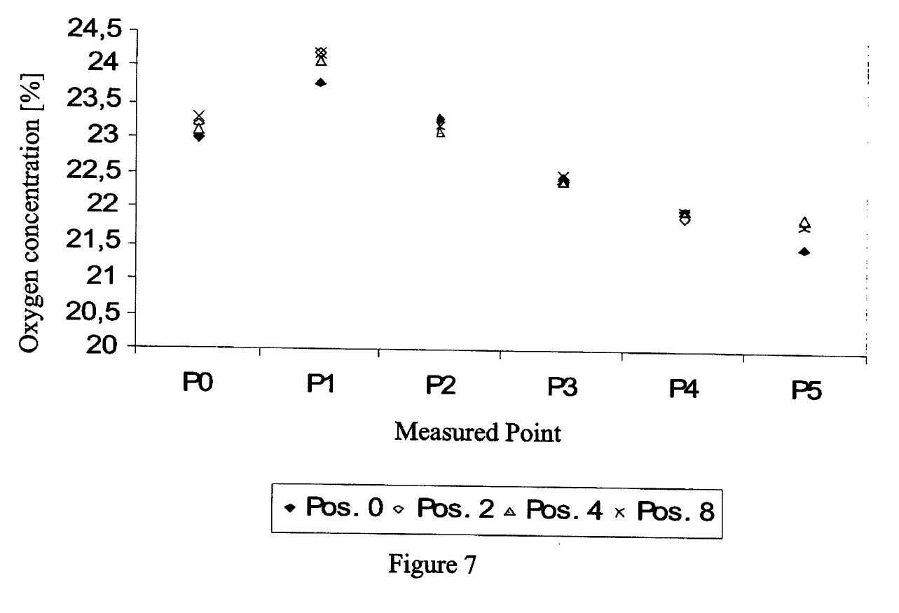

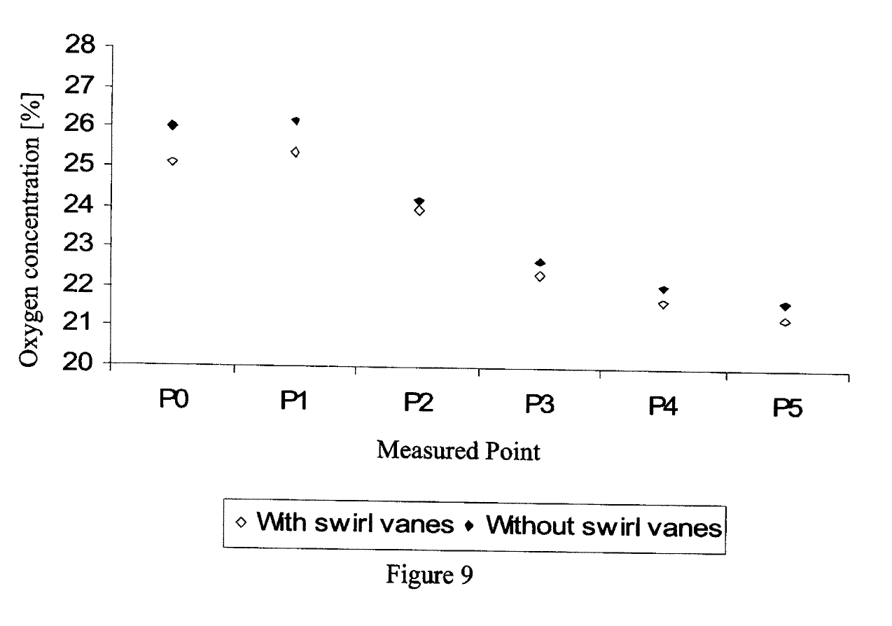

The device of FIG. 2 used to obtain the results shown in FIGS. 7 to 11 had the following dimensions:

| | |
|---|---|
| annular conduit (4) length | 500 mm; |
| inner pipe internal diameter | 57 mm; |
| inner pipe external diameter | 60 mm; |
| outer pipe internal diameter | 80 mm; |
| outer pipe external diameter | 86 mm; |
| oxygen supply pipe locations | 75 mm, 225 mm & 405 mm from inner |
| | pipe outlet; |
| fan | 2-type Zalman ZF 8020 ASH; |
| oxygen supply pipe 3A & 3B | |
| internal diameter | 3 mm; and |
| | oxygen supply pipe 3C cylindrical section |
| length | 50 mm |
| diameter | 16 cm. |

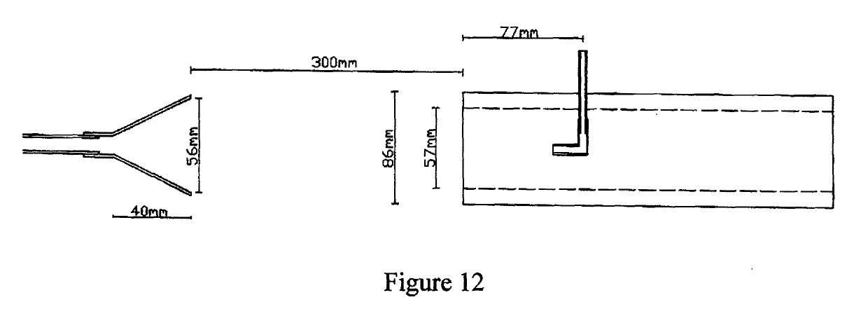

FIG. 12 shows an apparatus including a gas delivery device of FIG. 1 used for experimental purposes to investigate the effect on oxygen concentration at an axially spaced locus by varying oxygen flow rate and the voltage applied to the fan (not shown) at the inlet end of the device to provide air flow through the annular passage between the pipes. A funnel is located at the locus to direct gas received to an oxygen analyser (not shown) to measure oxygen concentration and can be adjusted between a coaxial position and with its axis angled at 45 degrees to that of the device. The apparatus used in Experiment 8 infra has the following dimensions:

| | |
|---|---|
| annular conduit length | 590 mm; |
| inner pipe internal diameter | 57 mm; |
| inner pipe external diameter | 60 mm; |
| outer pipe internal diameter | 80 mm; |
| oxygen supply pipe locations | 77 from inner pipe outlet; |
| funnel mouth diameter | 56 mm |
| funnel axial length | 40 mm |
| funnel stem internal diameter | 12 mm |
| tube connecting funnel with analyser | 8 mm internal diameter |
| funnel mouth to pipe outlet | 300 mm (coaxial funnel position) |
| fan (12 volt computer fan) | Zalman Quiet Fan |
| | (80 cm diameter) |

### Experiment 1 (Simulation)

The effect on diffusion of an oxygen jet from single and double pipe devices was evaluated using a computer simulation of a single pipe device and three variations of a double pipe device. The single pipe device had a right cylindrical pipe of 500 mm length and 80 mm diameter and all of the double pipe devices had inner and outer pipes each of 500 mm length. Two of the devices had an inner pipe diameter of 60 mm, one having an outer pipe diameter of 100 mm and the other an outer diameter of 80 mm. The third double pipe device had an inner diameter of 65 mm and an outer diameter of 80 mm. In all devices, the oxygen inlet was located 37 cm from the inner pipe inlet and was delivered by a supply pipe of the omnidirectional type shown in FIG. 3B having an internal diameter of 12 mm. The total flow rate for each device was 0.15 m³/min and the oxygen flow rate was 0.0045 m³/min. The single pipe device was fed under a virtual fan boundary condition of 0.10 m/s up to 0.015 m radial distance and 0.55 m/s thereafter with a rotational velocity of 80 rpm. The double pipe devices had the same air flow rate delivered to both the inner pipe and annular conduit both of which had piston velocity profiles set at their inlet with the annular conduit flow swirling at 80 rpm.

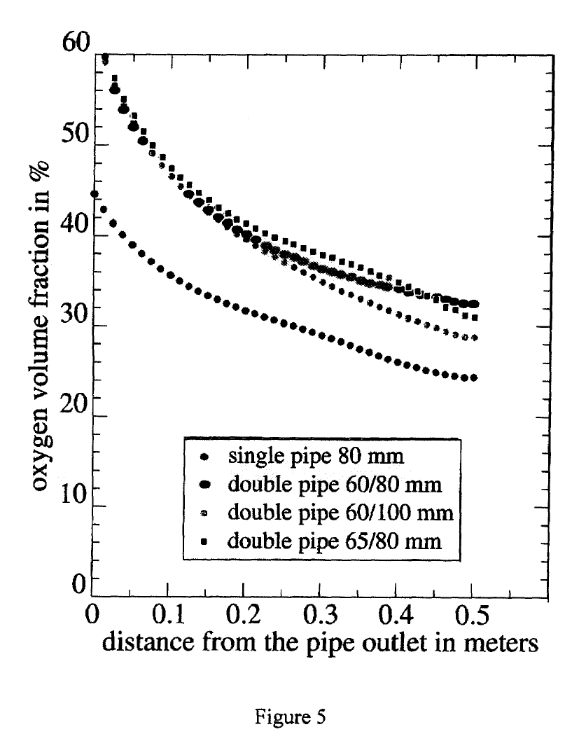

The oxygen volume fraction at the core of the gas jet exiting the inner pipe was calculated at distances up to 0.5 m and the results are shown in FIG. 5. It is apparent from this figure that oxygen will rapidly mix with the air within the inner pipe. Splitting the flows in the double pipe device is shown to reduce the amount of air with which the oxygen is mixed in the device resulting in higher oxygen concentration at the pipe outlet. The 65/80 design reduced oxygen diffusion from the jet to a distance of about 0.4 m but further downstream, the diffusion was more rapid than the 60/80 design.

The results shown in FIG. 5 show that the double pipe design is capable of providing significantly lower oxygen concentration drop at the jet core compared with a single pipe design.

### Experiment 2 (Simulation)

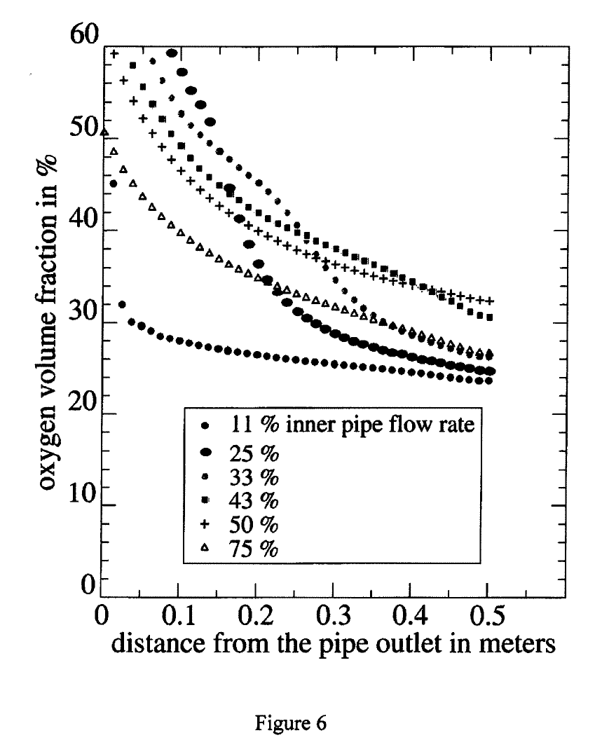

Using the 60/80 design of Experiment 1, the effect of varying the flow rate ratio between the inner pipe and the annular channel was investigated using the computer simulation. The total flow rate was 0.15 m³/min and measurements were calculated with the flow rate through the inner pipe constituting 11%, 25%, 33%, 43%, 50% & 75% of the total flow rate. The results are shown in FIG. 6. The lower ratios (viz. 11%, 25% & 33%) indicate that a recirculation zone will be created close to the pipe outlet thereby causing the oxygen to spread across the jet lowering its concentration. The highest ratio (viz. 75%) is predicted to have the same effect but the drop in concentration would be due to the high air speed and turbulence level within the inner pipe.

### Experiment 3 (Actual)

The device of FIG. 2 was operated with the movable part (10) located at POS.0, POS.2, POS.4 or POS.8; oxygen supplied at 0.005 m³/min by the supply pipe of FIG. 3A at location II; and with a total air flow rate of 0.15 m³/min. The results are shown in FIG. 6. Presently, the increase in concentration in the first 200 mm from the device cannot be explained.

### Experiment 4 (Actual)

Experiment 3 was repeated with the oxygen supply pipe of FIG. 3B. The results are shown in FIG. 7.

### Experiment 5 (Actual)

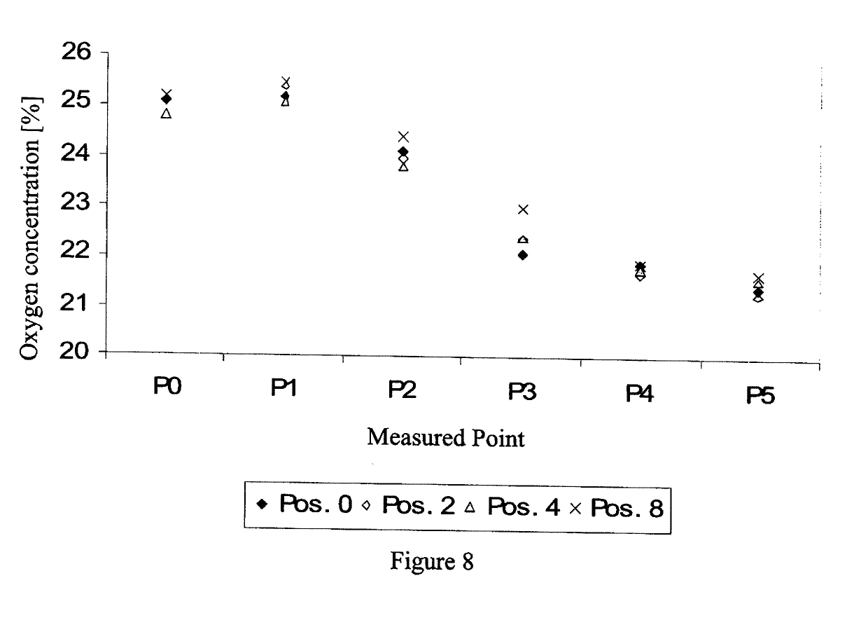

The procedure of Experiment 4 was repeated with the movable part (10) at POS.2 and with the swirl vanes (5) either in place or removed. The oxygen concentration in the jet core at 100 mm increments (P0-P5) up to 500 mm was measured. The results are set forth in FIG. 8.

It is believed that the drop in oxygen concentration when the vanes are present occurs because the vanes affect the pressure drop of the annular channel and so change the distribution of flow rates between the inner pipe and the annular channel. When the vanes are present, a larger flow rate is established through the annular conduit thus decreasing the flow rate through the inner pipe whereby, at the same oxygen supply flow rate, the oxygen concentration rises.

### Experiment 6 (Actual)

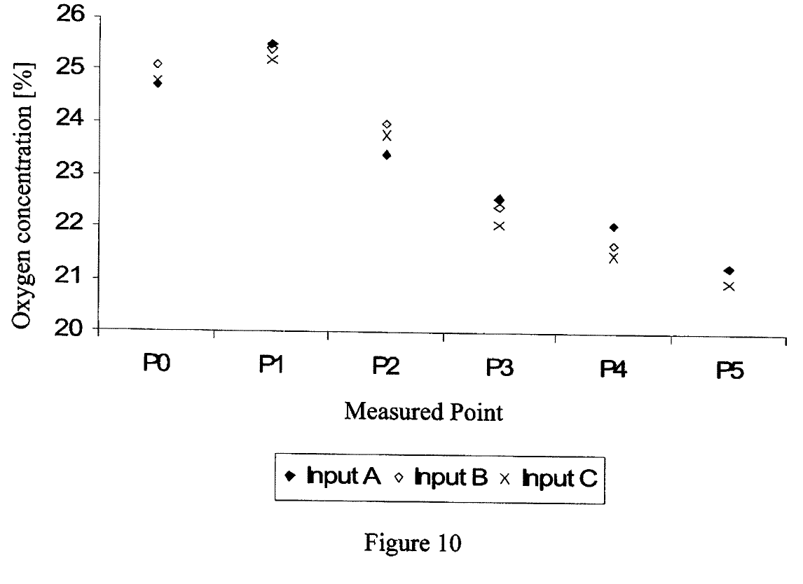

The procedure of Experiment 4 was repeated but with the oxygen supply pipe located respectively in each of the available locations (I, II or II). The results are shown in FIG. 10.

### Experiment 7 (Actual)

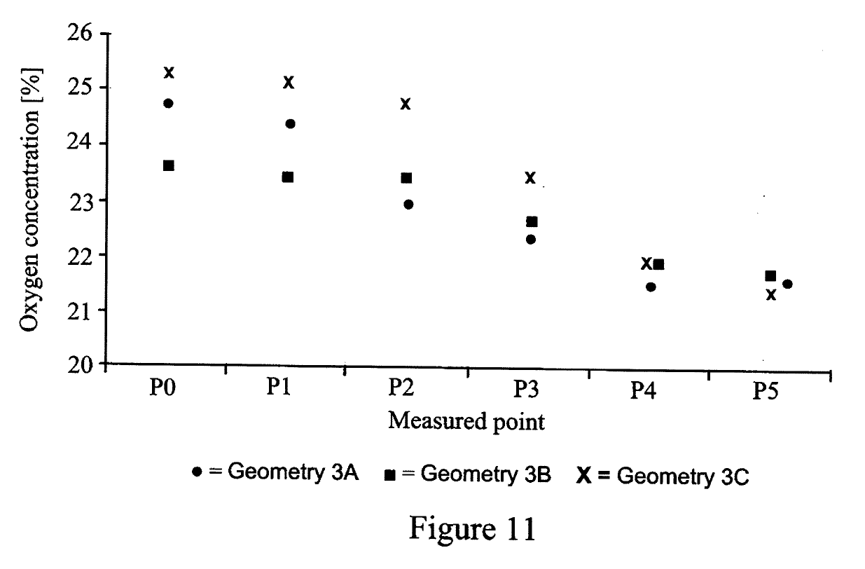

The device of FIG. 2 was operated with oxygen supplied at 0.005 m³/min by the supply pipe of FIG. 3A, 3B or 3C separately at that same location and with a total air flow rate of 0.15 m³/min. The results are shown in FIG. 11.

### Experiment 8 (Actual)

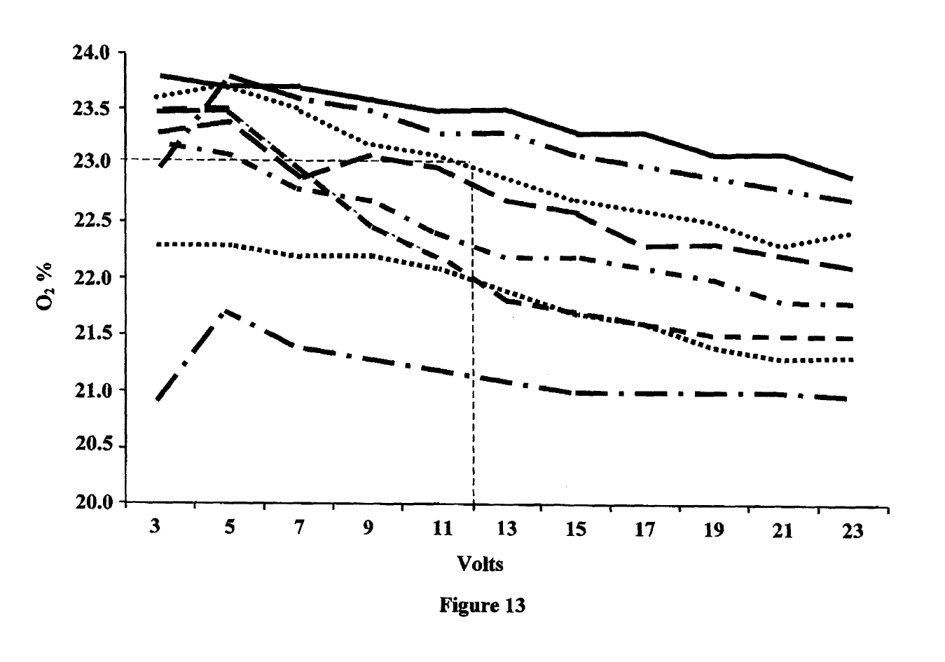

Oxygen was supplied to the apparatus of FIG. 12 from a concentrator or from a pure oxygen cylinder at different flow rates whilst the fan speed at the back of the delivery device was adjusted using a variable power supply. The oxygen concentrator was used to provide oxygen at 2, 5 and 9 litres/min and the oxygen cylinder supply used to provide oxygen at 10, 20 and 30 litres/min. The fan voltage was adjusted between 3 and 23 volts at 2 volt intervals. 6 sets of tests were done with the funnel coaxially aligned with the device and 2 additional set of tests were performed with the funnel at an angle of 45 degrees to the pipe axis. The results are set forth in Table 1 infra and shown graphically in FIG. 13. The following line styles are used in FIG. 13.

| | | |
|---|---|---|
| [symbol] | 2 | l/min |
| [symbol] | 5 | l/min |
| [symbol] | 9 | l/min |
| [symbol] | 10 | l/min |
| [symbol] | 20 | l/min |
| [symbol] | 20 | l/min (angled) |
| [symbol] | 30 | l/min |
| [symbol] | 30 | l/min (angled) |

This experiment was conducted to replicate a preferred arrangement in which the delivery tube does not directly face the mouth of the user, in which case returning exhaled breath would disrupt the gas flow. At an angle, the exhaled breath only disturbs the last section of the flow regime. The angle of 45 degrees is a convenient angle for mounting at the base of a running machine, pointing up and achieves a balance between being too face-on and too oblique an impact angle to be effective.

Aspects and embodiments of the invention include:

#1. A method of delivering a gas to a locus comprising feeding a first gas to the inlet of the inner pipe (2) of a gas delivery device (1), which device is spaced from the locus and comprises an inner pipe (2) having an inlet at one end and an outlet at the other end and an outer pipe (3) axisymmetrical with and surrounding said inner pipe (2) to form an annular conduit (4) having an inlet at said one end and an outlet at said other end, and feeding a second gas to the inlet of the annular conduit (4), wherein gas issues from the inner pipe outlet as a laminar flow jet impinging on the locus and surrounded by a turbulent flow annular sleeve issuing from the annular conduit and constraining diffusion of said jet until at least said locus.

#2. A method according to #1, wherein the compositions of said first and second gases differ.

#3. A method according to #1, wherein the compositions of said first and second gases are the same and matter is introduced into the inner pipe (2) at an intermediate location to change the composition of the gas flowing therethrough.

#4. A method according to #3, wherein the matter is introduced omnidirectionally.

#5. A method according to #3, wherein the matter is introduced isokinetically.

#6. A method according to any preceding #, wherein the composition of the jet and the annular sleeve differ in that the jet contains a higher concentration of a common component.

#7. A method according to #5, wherein the common component is oxygen.

#8. A method according to #6, wherein the jet is oxygen-enriched air containing about 22 to about 25% oxygen and the annular sleeve is normoxic air.

#9. A method according to #8, wherein the first gas is oxygen-enriched air containing about 22 to about 25% oxygen and the second gas is normoxic air.

#10. A method according to #8, wherein the first and second gases are normoxic air and oxygen is fed into the inner pipe (2) at an intermediate location to mix with the air therein to increase the oxygen concentration thereof to about 22 to about 25%.

#11. A method according to any preceding #, wherein the flow exiting the annular conduit has a Reynolds Number of at least about 3000.

#12. A method according to any preceding #, wherein the flow exiting the annular conduit has a swirl of about 80 to about 800 rpm.

#13. A method according to any preceding #, wherein the jet has a rotational velocity of less than about 60 rpm.

#14. A method according to any preceding #, wherein the linear flow velocity of the gas exiting the inner pipe outlet is about 30 to about 65 m/s.

#15. A method according to #14, wherein said linear flow velocity is about 45 to about 55 m/s.

#16. A method according to #15, wherein said linear flow velocity is about 50 m/s.

#17. A method according to any preceding #, wherein the inner pipe outlet is spaced about 200 to about 500 mm (about 8 to about 20 in) from the locus.

#18. A method according to #17, wherein said distance is about 300 to about 350 mm (about 12 to about 14 in).

#19. A method according to any preceding #, wherein the inner and outer pipes (2, 3) are substantially coextensive right circular pipes.

#20. A method according to any preceding #, wherein the annular conduit (4) has a length at least about 6 times the diameter of the inner pipe (2).

#21. A method according to #20, wherein the annular conduit (4) length is about 0.3 to about 0.75 m (about 12 to about 30 in), the inner pipe (2) diameter is about 40 to about 140 mm (about 1.5 to about 5.5 in), and the outer pipe (3) diameter is about 50 to about 150 mm (about 2 to about 6 in).

#22. A method according to #21, wherein the annular conduit (4) length is about 0.4 to about 0.6 m (about 15 to about 24 in), the inner pipe (2) diameter is about 50 to about 100 mm (about 2 to about 4 in) and the outer pipe (3) diameter is about 60 to about 120 mm (about 2 25 to about 4.75 in).

#23. A method according to #22, wherein the annular conduit (4) length is about 0.45 to about 0.55 m (about 17 to about 22 in), the inner pipe (2) diameter is about 50 to about 70 mm (about 2 to about 2.75 in) and the outer pipe (3) diameter is about 70 to about 100 mm (about 2 75 to about 4 in).

#24. A method according to any preceding #, wherein the inner pipe (2) and outer pipe (3) terminate at their outlets in the same plane.

#25. A method according to any preceding #, wherein at the outlet end the inner pipe (2), outer pipe (3) or both the inner pipe (2) and the outer pipe (3) gradually decrease in wall thickness in the flow direction to minimize flow disruption on debauching from the pipe.

#26. A method according to any preceding #, wherein the cross-sectional area of the inner pipe (2) is not more than about 25% greater or smaller than the annular conduit (4).

#27. A method according to #26, wherein said cross-sectional areas are substantially the same.

#28. A method according to any preceding #, wherein the axial flow velocity in the inner pipe (2) is not more than about 25% greater or smaller than the axial flow velocity in the annular conduit (4).

#29. A method according to #28, wherein said the velocities are substantially the same.

#30. A gas delivery device (1) for use in a method of #1 comprising:

an inner pipe (2) having an inlet at one end and an outlet at the other end and through which pipe a gas can flow from the inlet to exit at the outlet as a laminar flow jet;

an outer pipe (3) axisymmetrical with and surrounding said inner pipe (2) to form an annular conduit (4) having an inlet at one end and an outlet at the other end and through which conduit a gas can flow from the inlet to exit at the outlet as a turbulent sleeve surrounding said jet; and

a supply pipe (6) for introducing matter into the inner pipe (2) at an intermediate location thereof to change the composition of the gas flowing therethrough.

#31. A gas delivery device according to #30, wherein the supply pipe (6) introduces matter omnidirectionally into the inner pipe (4).

#32. A gas delivery device according to #34, wherein the supply pipe (6) introduces matter isokinetically into the inner pipe (4).

#33. A gas delivery device according to any of #30 to #32, wherein the respective inlets of the inner and outer pipes (2, 3) are connected to a common manifold (7) whereby gas of the same composition enters both the inner pipe (2) and the annular conduit (4).

#34. A gas delivery device according to any of #30 to #33, wherein said device comprises air supply means (7) for supplying normoxic air to the inner pipe (2) and annular conduit (4) and the supply pipe (6) is connected to a source of oxygen.

#35. A gas delivery device according to #34, wherein said air supply means comprises a fan (7) for feeding ambient air into the inner pipe (2) and annular conduit (4).

#36. A gas delivery device according to any of #30 to #35, wherein the inner and outer pipes (2, 3) are substantially coextensive.

#37. A gas delivery device according to any of #30 to #36, wherein the inner and outer pipes (2, 3) are right circular pipes.

#38. A gas delivery device according to any of #30 to #37, wherein the annular conduit (4) has a length at least about 6 times the diameter of the inner pipe (2).

#39. A gas delivery device according to #38, wherein the annular conduit (4) length is about 0.3 to about 0.75 m (about 12 to about 30 in), the inner pipe (2) diameter is about 40 to about 140 mm (about 1.5 to about 5.5 in) and the outer pipe (3) diameter is about 50 to about 150 mm (about 2 to about 6 in).

#40. A gas delivery device according to #39, wherein the annular conduit (4) length is about 0.4 to about 0.6 m (about 15 to about 24 in), the inner pipe (2) diameter is about 50 to about 100 mm (about 2 to about 4 in) and the outer pipe (3) diameter is about 60 to about 120 mm (about 2 25 to about 4.75 in).

#41. A gas delivery device according to #40, wherein the annular conduit (4) length is about 0.45 to about 0.55 m (about 17 to about 22 in), the inner pipe (2) diameter is about 50 to about 70 mm (about 2 to about 2.75 in) and the outer pipe (3) diameter is about 70 to about 100 mm (about 2 75 to about 4 in).

#42. A gas delivery device according to any of #30 to #41, comprising vanes (5) imparting swirl to the annular sleeve.

#43. A gas delivery device according to #42, wherein said vanes (5) are located at the outlet of the annular conduit (4).

#44. A gas delivery device according to any of #30 to #43, wherein the inner pipe (2) and outer pipe (3) terminate at their outlets in the same plane.

#45. A gas delivery device according to any of #30 to #44, wherein at the outlet end the inner pipe (2), outer pipe (3) or both the inner and outer pipes gradually decrease in wall thickness in the flow direction to minimize flow disruption on debouching from the pipe.

#46. A gas delivery device according to any of #30 to #45, wherein the cross-sectional area of the inner pipe (2) is not more than about 25% greater or smaller than the annular conduit (4).

#47. A gas delivery device according to #46, wherein said cross-sectional areas are substantially the same.

#48. A method according to #1, wherein the gas delivery device is as defined in any one of #30 to 47.

It will be appreciated that the invention is not restricted to the details described above with reference to the preferred embodiments but that numerous modifications and variations can be made without departing from the spirit and scope of the invention as defined in the following claims. In particular, although the invention has particular application to the supply of oxygen-enriched air for inhalation by persons undertaking exercise, controlling or travelling in a vehicle, especially a motor car, or having breathing difficulties such as patients with chronic obstructive pulmonary disease (COPD) the invention is not restricted to such use and both the method and device aspects have other applications. For example, the invention can be applied to brazing or welding type applications, in which, for example, reactive gas is supplied to the inner pipe and an inert gas is supplied to the annular conduit or a welding shielding gas supplied to the inner pipe and normoxic air supplied to the annular conduit. It also can be applied to clean room applications, in which, for example a purified contaminant-free gas is supplied to the inner pipe and atmospheric air is supplied to the annular conduit.

TABLE 1

| | O₂ flow | | | | | | | |
|---|---|---|---|---|---|---|---|---|
| | 2 | 5 | 9 | 10 | 20 | 20 | 30 | 30 |
| | Funnel position | | | | | | | |
| | coaxial | coaxial | coaxial | coaxial | coaxial | angled | coaxial | angled |
| Fan Voltage | O₂ concentration (l/min) | | | | | | | |
| 3 | 20.9 | 22.3 | 23.2 | 23.5 | 23.3 | 23.6 | 23.0 | 23.8 |
| 5 | 21.7 | 22.3 | 23.1 | 23.5 | 23.4 | 23.7 | 23.8 | 23.7 |
| 7 | 21.4 | 22.2 | 22.8 | 23.0 | 22.9 | 23.5 | 23.6 | 23.7 |
| 9 | 21.3 | 22.2 | 22.7 | 22.5 | 23.1 | 23.2 | 23.5 | 23.6 |
| 11 | 21.2 | 22.1 | 22.4 | 22.2 | 23.0 | 23.1 | 23.3 | 23.5 |
| 13 | 21.1 | 21.9 | 22.2 | 21.8 | 22.7 | 22.9 | 23.3 | 23.5 |
| 15 | 21 | 21.7 | 22.2 | 21.7 | 22.6 | 22.7 | 23.1 | 23.3 |
| 17 | 21 | 21.6 | 22.1 | 21.6 | 22.3 | 22.6 | 23.0 | 23.3 |
| 19 | 21 | 21.4 | 22 | 21.5 | 22.3 | 22.5 | 22.9 | 23.1 |
| 21 | 21 | 21.3 | 21.8 | 21.5 | 22.2 | 22.3 | 22.8 | 23.1 |
| 23 | 20.95 | 21.3 | 21.8 | 21.5 | 22.1 | 22.4 | 22.7 | 22.9 |

1. A method of delivering a gas to a locus comprising feeding a first gas to the inlet of the inner pipe of a gas delivery device, which device is spaced from the locus and comprises an inner pipe having an inlet at one end and an outlet at the other end and an outer pipe axisymmetrical with and surrounding said inner pipe to form an annular conduit having an inlet at said one end and an outlet at said other end, and feeding a second gas to the inlet of the annular conduit, wherein gas issues from the inner pipe outlet as a laminar flow jet impinging on the locus and surrounded by a turbulent flow annular sleeve issuing from the annular conduit and constraining diffusion of said jet until at least said locus.

2. A method according to claim 1, wherein the compositions of said first and second gases differ.

3. A method according to claim 1, wherein the compositions of said first and second gases are the same and matter is introduced into the inner pipe at an intermediate location to change the composition of the gas flowing therethrough.

4. A method according to claim 3, wherein the matter is introduced in a manner selected from omnidirectionally and isokinetically.

5. A method according to claim 1, wherein the composition of the jet and the annular sleeve differ in that the jet contains a higher concentration of a common component.

6. A method according to claim 5, wherein the first and second gases are normoxic air and oxygen is fed into the inner pipe at an intermediate location to mix with the air therein to increase the oxygen concentration thereof to about 22 to about 25%.

7. A method according to claim 1, wherein the inner pipe outlet is spaced about 8 to about 20 in from the locus.

8. A method according to claim 1, wherein the inner and outer pipes are substantially coextensive right circular pipes.

9. A method according to claim 1, wherein the annular conduit has a length at least about 6 times the diameter of the inner pipe.

10. A method according to claim 5, wherein the inner pipe outlet is spaced about 8 to about 20 in from the locus.

11. A method according to claim 5, wherein the inner and outer pipes are substantially coextensive right circular pipes.

12. A method according to claim 5, wherein the annular conduit has a length at least about 6 times the diameter of the inner pipe.

13. A gas delivery device for use in a method of claim 1 comprising:
an inner pipe having an inlet at one end and an outlet at the other end and through which pipe a gas can flow from the inlet to exit at the outlet as a laminar flow jet;
an outer pipe axisymmetrical with and surrounding said inner pipe to form an annular conduit having an inlet at one end and an outlet at the other end and through which conduit a gas can flow from the inlet to exit at the outlet as a turbulent sleeve surrounding said jet; and
a supply pipe for introducing matter into the inner pipe at an intermediate location thereof to change the composition of the gas flowing therethrough.

14. A gas delivery device according to claim 13, wherein the respective inlets of the inner and outer pipes are connected to a common manifold whereby gas of the same composition enters both the inner pipe and the annular conduit.

15. A gas delivery device according to claim 13, wherein said device comprises air supply means for supplying normoxic air to the inner pipe and annular conduit and the supply pipe is connected to a source of oxygen.

16. A gas delivery device according to claim 13, wherein the annular conduit has a length at least about 6 times the diameter of the inner pipe.

17. A gas delivery device according to claim 13, wherein the inner and outer pipes terminate at their outlets in the same plane.

18. A gas delivery device according to claim 13, wherein at the outlet end the inner pipe, outer pipe or both the inner and outer pipes gradually decrease in wall thickness in the flow direction to minimize flow disruption on debouching from the pipe.

19. A gas delivery device according to claim 15, wherein the annular conduit has a length at least about 6 times the diameter of the inner pipe.

20. A gas delivery device according to claim 15, wherein at the outlet end the inner pipe, outer pipe or both the inner and outer pipes gradually decrease in wall thickness in the flow direction to minimize flow disruption on debouching from the pipe
